(19) United States
(12) Patent Application Publication
(10) Pub. No.: US 2019/0285832 A1
(43) Pub. Date: Sep. 19, 2019

(54) LENS BARREL WITH SLIT THROUGH WHICH WIRING IS LET OUT, AND IMAGE PICKUP APPARATUS

(71) Applicant: CANON KABUSHIKI KAISHA, Tokyo (JP)

(72) Inventor: Nobuyoshi Suzuki, Tokyo (JP)

(21) Appl. No.: 16/296,661

(22) Filed: Mar. 8, 2019

(30) Foreign Application Priority Data
Mar. 14, 2018 (JP) 2018-046802

(51) Int. Cl. G02B 7/04; G02B 7/02

(52) U.S. Cl. CPC G02B 7/04; G02B 7/021

(57) ABSTRACT

A lens barrel includes a flexible printed circuit board. The lens barrel incudes a driving cylinder on which at least three first cam grooves are formed and a slit through which the flexible printed circuit board is inserted is formed in a circumferential direction. The lens barrel includes a first optical group holding frame configured to move in a direction of an optical axis by following the at least three first cam grooves. The slit crosses the at least three first cam grooves in the direction of the optical axis, and the at least three first cam grooves are formed at different locations in the direction of the optical axis with respect to a beginning and an end of the slit.

### BACKGROUND OF THE INVENTION

### Field of the Invention

The present invention relates to a lens barrel installed in an image pickup apparatus such as a digital camera or a digital video camera, and the image pickup apparatus equipped with the lens barrel.

### Description of the Related Art

There has been a high demand for increasing zooming magnification of an image pickup apparatus such as a digital camera while slimming down its main body. Accordingly, an arrangement for downsizing the main body of the image pickup apparatus by increasing moving strokes of lens groups to the extent possible.

In a collapsible zoom lens barrel, to secure enough moving strokes of lens groups, it is necessary to form cam grooves on a cam cylinder such that the cam grooves extend in a direction of an optical axis. For example, there is needed an arrangement in which cam grooves are formed over the whole length of one extended cam cylinder in the direction of the optical axis to earn enough moving stroke of a lens group inside the cam cylinder, and cam grooves are also formed outside the cam cylinder to hold a lens group and move it in the direction of the optical axis. Moreover, the number of lens groups constituting a lens barrel has been increasing so as to improve optical performance. proposed an arrangement in which cam grooves for moving a lens group in a direction of an optical axis are formed on a driving cylinder which rotates so as to move a cam cylinder in the direction of the optical axis while rotating it so that an increased number of lens groups can be driven. According to this proposal, a slit for letting out wiring for a shutter member and others inside a lens barrel is formed in the driving cylinder, and the slit is formed a predetermined distance away from the cam grooves in the direction of the optical axis so as to avoid interference with the cam grooves.

According to Japanese Laid-Open Patent Publication (Kokai) No. 2016-57424, however, when the lens group which is moved by the driving cylinder has a long moving stroke, a slit can be formed only on a subject side or an image plane side of the driving cylinder in the direction of the optical axis so as to avoid interference of the slit formed in the driving cylinder with the cam grooves. For this reason, problems may arise because, for example, wiring for the shutter member and others cannot be provided inside the lens barrel, and wiring let out from the barrel cannot be connected to a printed circuit of the camera.

Moreover, when the slit and the cam grooves are arranged parallel in a circumferential direction of the driving cylinder, a circumference of the slit, that is, a moving range of the driving cylinder has to be decreased so as to avoid interference of the three cam grooves formed on the driving cylinder with the slit. Therefore, the rotational angle with respect to the moving stroke of the lens group will be decreased to make the lift of the cam grooves steeper, and as a result, the sensitivity of the lens group in terms of position, inclination, and so forth to rattling in the cam grooves will be worsened.

### SUMMARY OF THE INVENTION

The present invention provides a lens barrel which widens a moving range of a driving cylinder having a slit through which wiring for members inside the lens barrel is let out from the lens barrel, and an image pickup apparatus equipped with the lens barrel.

Accordingly, the present invention provides a lens barrel including a flexible printed circuit board, a driving cylinder on which at least three first cam grooves are formed and a slit through which the flexible printed circuit board is inserted is formed in a circumferential direction, and a first optical group holding frame configured to move in a direction of an optical axis by following the at least three first cam grooves, wherein the slit crosses the at least three first cam grooves in the direction of the optical axis, and the at least three first cam grooves are formed at different locations in the direction of the optical axis with respect to a beginning and an end of the slit.

According to the present invention, a moving range of the driving cylinder having the slit through which wiring for members inside the lens barrel is let out from the lens barrel is widened.

Further features of the present invention will become apparent from the following description of exemplary embodiments (with reference to the attached drawings).

### BRIEF DESCRIPTION OF THE DRAWINGS

FIG. 1 is a cross-sectional view of a lens barrel according to an embodiment of the present invention when it is collapsed.

FIG. 2 is a cross-sectional view of the lens barrel in FIG. 1 at the time of photo shooting.

FIG. 3 is an exploded perspective view of the lens barrel in FIG. 1.

FIG. 4 is a side view of a group-4 holding frame.

FIG. 5 is a side view of a group-6 holding frame.

FIG. 6 is a developed view of an inner periphery of a fixed cylinder.

FIG. 7 is a developed view of an inner periphery of a driving cylinder.

FIG. 8 is a partially enlarged view of FIG. 7.

FIG. 9 is a partially enlarged view of FIG. 7.

FIG. 10 is a perspective view of the lens barrel in a state where FPCs of an image blur correction device and a diaphragm device are let out from the lens barrel.

### DESCRIPTION OF THE EMBODIMENTS

An embodiment of the present invention will now be described with reference to the drawings.

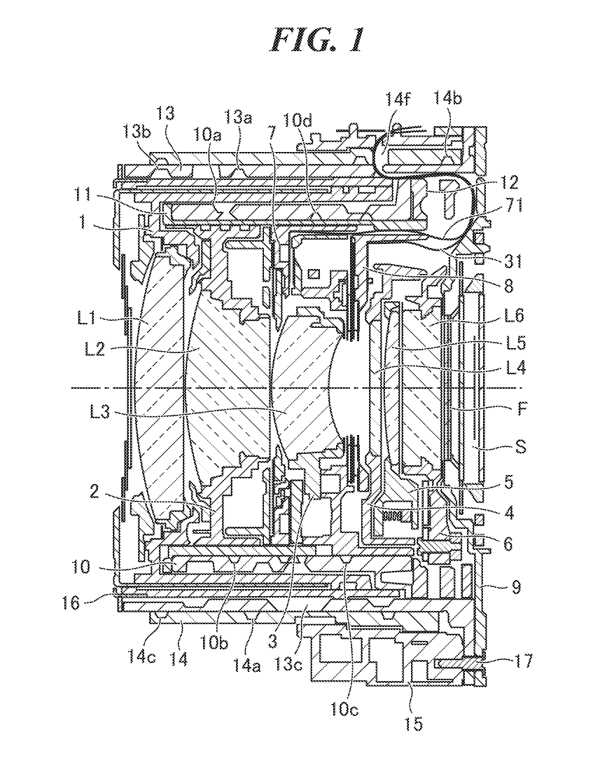

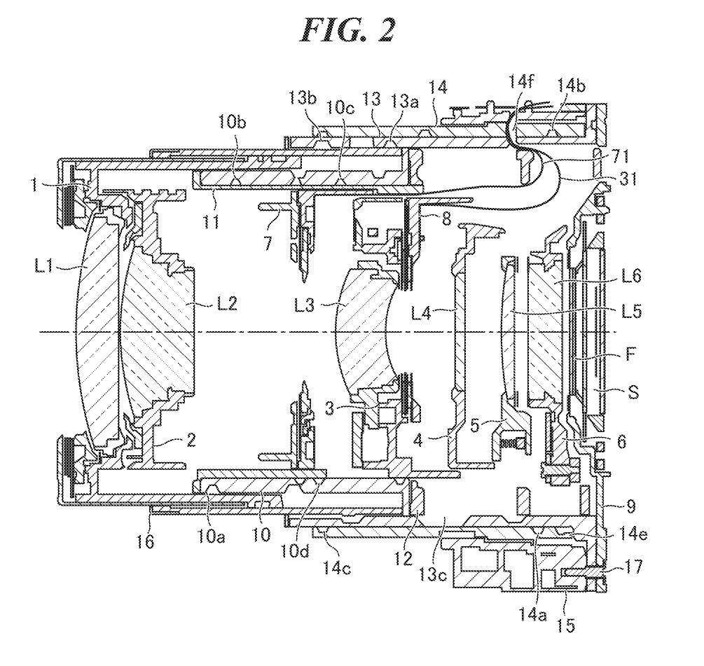

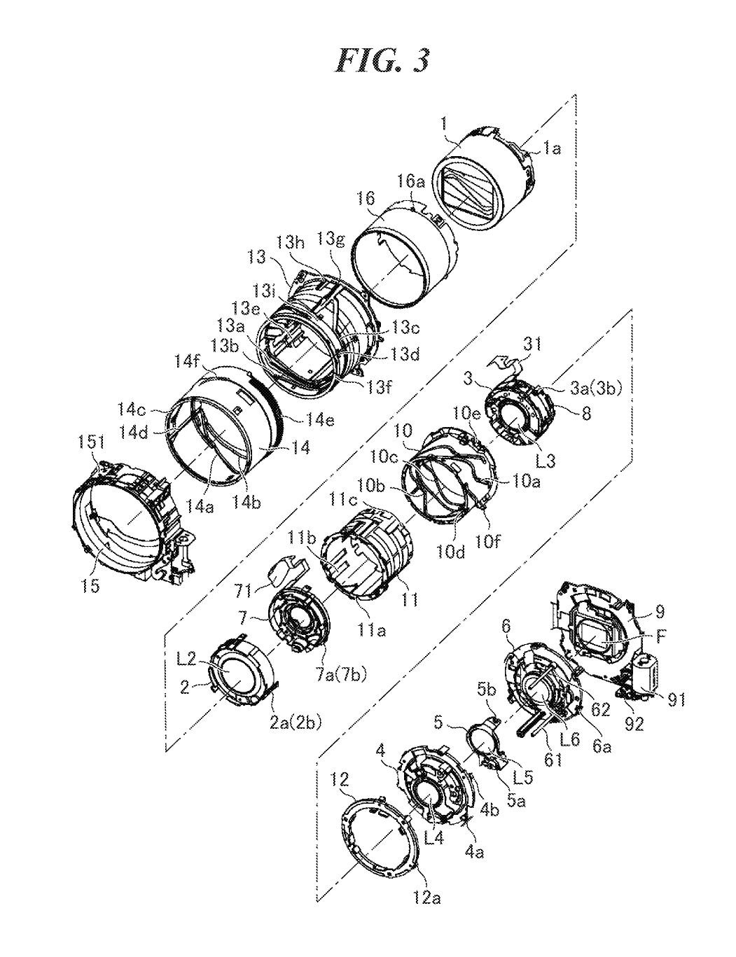

FIG. 1 is a cross-sectional view of a lens barrel according to an embodiment of the present invention when it is collapsed. FIG. 2 is a cross-sectional view of the lens barrel in FIG. 1 at the time of photo shooting. FIG. 3 is an exploded perspective view of the lens barrel in FIG. 1. It should be noted that in the present embodiment, the lens barrel used in a digital contact camera which is an example of an image pickup apparatus is illustrated, but the present invention is not limited to this.

The lens barrel according to the present embodiment is a six-group lens optical system containing a group-1 lens L1, a group-2 lens L2, a group-3 lens L3, a group-4 lens L4, a group-5 lens L5, and a group-6 lens L6 as shown in FIGS. 1 to 3.

A group-1 cylinder 1 holds the group-1 lens L1, and a group of six cam pins 1a provided in the group-1 cylinder 1 is engaged with cam grooves 10a formed on an outer peripheral surface of a cam cylinder 10. Rectilinear grooves, not shown, are formed at three locations of an inner peripheral surface of the group-1 cylinder 1 in a circumferential direction, and the rectilinear grooves are engaged with rectilinear keys 11a formed on an outer peripheral surface of a rectilinear cylinder 11.

A group-2 cylinder 2 holds the group-2 lens L2, and a group of three cam pins 2a provided on an outer peripheral surface of the group-2 cylinder 2 is engaged with cam grooves 10b formed on an inner peripheral surface of the cam cylinder 10. On the group-2 cylinder 2, rectilinear keys 2b are formed at the same locations as the cam pins 2a, and the rectilinear keys 2b are engaged with rectilinear grooves 11b formed on the rectilinear cylinder 11.

An image blur correction device 3 holds the group-3 lens L3. A group of three cam pins 3a provided on an outer peripheral surface of the group-3 cylinder 3 is engaged with cam grooves 10c formed on the inner peripheral surface of the cam cylinder 10. On the image blur correction device 3, rectilinear keys 3b are formed at the same locations as the cam pins 3a, and the rectilinear keys 3b are engaged with rectilinear grooves 11c formed on the rectilinear cylinder 11. A shutter ND device 8 is fixed to the image blur correction device 3 by screws, not shown.

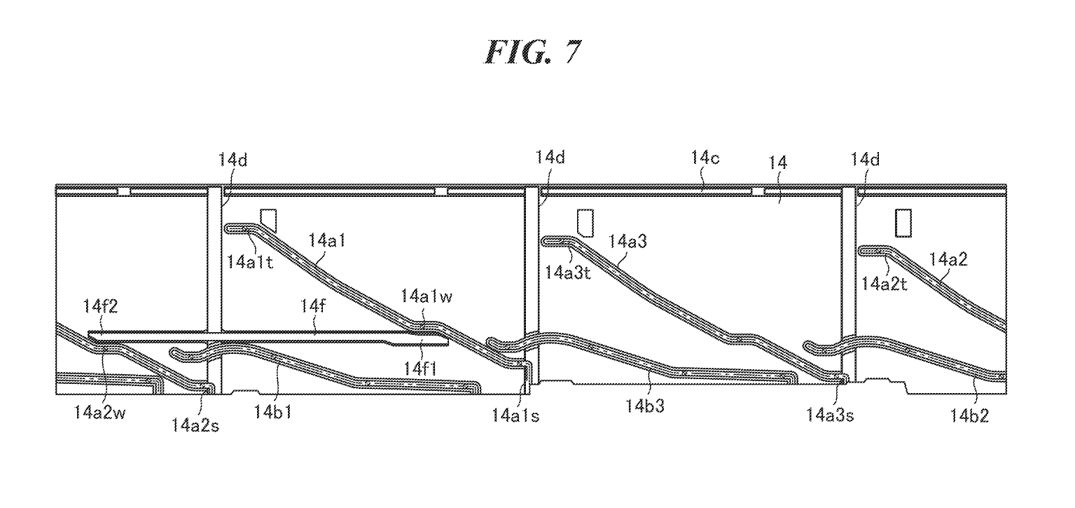

A group-4 holding frame (first optical group holding frame) 4 holds the group-4 lens L4. A group of three cam pins 4a1 to 4a3 (see FIG. 3) provided on an outer peripheral surface of the group-4 holding frame 4 is engaged with cam grooves 14a1 to 14a3 (first cam grooves, see FIG. 7) formed on an inner peripheral surface of a driving cylinder 14, respectively, and is followed. Rectilinear keys 4b are formed at three locations on an outer peripheral surface of the group-4 holding frame 4, and the rectilinear keys 4b are engaged with rectilinear grooves 13d formed on a fixed cylinder 13.

A group-5 holding frame 5 holds the group-5 lens L5. A positioning portion 5a and a shake stopping portion 5b formed on the group-5 holding frame 5 are engaged with guide bars 61 and 62, respectively, provided on a group-6 holding frame 6 to support the group-5 holding frame 5 movably in a direction of an optical axis. The group-5 holding frame 5 is provided with a rack, not shown, which is screwed to a stepping motor 63 provided on the group-6 holding frame 6. When the group-5 holding frame 5 is driven by power from the stepping motor 63, the group-5 holding frame 5 is caused to move in the direction of the optical axis by actions of the positioning portion 5a, the shake stopping portion 5b, and the guide bars 61 and 62 without rotating.

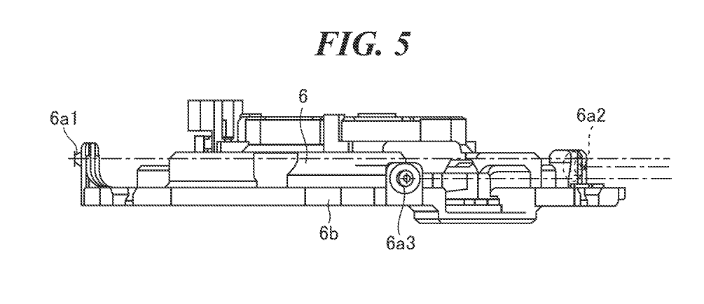

The group-6 holding frame 6 (second optical group holding frame) holds the group-6 lens L6. A group of three cam pins 6a1 to 6a3 (see FIG. 5) disposed in a lower part of an outer peripheral surface of the group-6 holding frame 6 is engaged with cam grooves 14b1 to 14b3 (second cam grooves, see FIG. 7) formed on the inner peripheral surface of the driving cylinder 14, respectively. Rectilinear keys 6b are formed at three locations on the outer peripheral surface of the group-6 holding frame 6, and the rectilinear keys 6b are engaged with rectilinear grooves 13e formed on the fixed cylinder 13.

A diaphragm device 7 has a group of three cam pins 7a provided on an outer peripheral surface of the diaphragm device 7 and engaged with cam grooves 10d formed on the inner peripheral surface of the cam cylinder 10. On the diaphragm device 7, rectilinear keys 7b are formed at the same locations as the cam pins 7a, and the rectilinear keys 7b are engaged with rectilinear grooves 11d formed on the rectilinear cylinder 11.

A group of three cam pins 10e provided on the outer peripheral surface of the cam cylinder 10 is engaged with cam grooves 13a formed on the inner peripheral surface of the fixed cylinder 13. A group of three driving pins 10f provided on the outer peripheral surface of the cam cylinder 10 penetrates through grooves 13c formed on the fixed cylinder 13 and are engaged with rectilinear grooves 14d formed on the inner peripheral surface of the driving cylinder 14. The cam cylinder 10 is rotatively sandwiched between the rectilinear cylinder 11 and a rectilinear plate 12 and moves integrally with the rectilinear cylinder 11 in the direction of the optical axis.

A movable cover cylinder 16 is fixed to the cam cylinder 10 by a fixing means, not shown. A group of three cam pins 16a provided on an outer peripheral surface of the movable cover cylinder 16 is inserted into cam grooves 13b formed on the fixed cylinder 13 with a slight clearance left between them.

The rectilinear cylinder 11 restricts linear movement of the group-1 cylinder 1, the group-2 cylinder 2, the image blur correction device 3, and the diaphragm device 7 and is fixed to the rectilinear plate 12 by a fixing means, not shown. Three rectilinear keys 12a formed on an outer peripheral surface of the rectilinear plate 12 are engaged with respective rectilinear grooves 13f formed on the fixed cylinder 13, respectively.

A gear portion 14e formed on an outer peripheral surface of the driving cylinder 14 is connected to a driving device constituted of a DC motor 91 and a plurality of gears 92. When the driving cylinder 14 is rotated by output from the driving device, the cam cylinder 10 is caused to move in the direction of the optical axis by an action of the cam pins 10e of the cam cylinder 10 with the cam grooves 13a of the fixed cylinder 13 and an action of the driving pins 10f of the cam cylinder 10 with the rectilinear grooves 14d of the driving cylinder 14 while rotating.

The group-1 cylinder 1 is caused to move in the direction of the optical axis by an action of the cam pins 1a of the group-1 cylinder 1 with the cam grooves 10a of the cam cylinder 10 and an action of rectilinear grooves (not shown) of the group-1 cylinder 1 with the rectilinear keys 11a of the rectilinear cylinder 11 without rotating.

The group-2 cylinder 2 is caused to move in the direction of the optical axis by an action of the cam pins 2a of the group-2 cylinder 2 with the cam grooves 10b of the cam cylinder 10 and an action of the rectilinear keys 2b of the group-2 cylinder 2 with the rectilinear grooves 11b of the rectilinear cylinder 11 without rotating.

The image blur correction device 3 is caused to move in the direction of the optical axis by an action of the cam pins 3a of the image blur correction device 3 with the cam grooves 10c of the cam cylinder 10 and an action of the rectilinear keys 3b of the image blur correction device 3 with the rectilinear grooves 11c of the rectilinear cylinder 11 without rotating.

The group-4 holding frame 4 is caused to move in the direction of the optical axis by an action of the cam pins 4a1 to 4a3 of the group-4 cylinder 4 with the cam grooves 14a1 to 14a3 of the driving cylinder 14 and an action of the rectilinear keys 4b of the group-4 holding frame 4 with the rectilinear grooves 13d of the fixed cylinder 13 without rotating.

The group-6 holding frame 6 is caused to move in the direction of the optical axis by an action of the cam pins 6a1 to 6a3 of the group-6 holding frame 6 with the cam grooves 14b1 to 14b3 of the driving cylinder 14 and an action of the rectilinear keys 6b of the group-6 holding frame 6 with the rectilinear grooves 13e of the fixed cylinder 13 without rotating.

The diaphragm device 7 is caused to move in the direction of the optical axis by an action of the cam pins 7a of the diaphragm device 7 with the cam grooves 10d of the cam cylinder 10 and an action of the rectilinear keys 7b of the diaphragm device 7 with the rectilinear grooves 11d of the rectilinear cylinder 11 without rotating. An image pickup element S and an optical filter F are held by a fixed base plate 9. The fixed cylinder 13 and a fixed cover cylinder 15 are fixed to the fixed base plate 9 by a screw 17. Here, the group-1 cylinder 1, the group-2 cylinder 2, the image blur correction device 3, and the diaphragm device 7 correspond to an example of a third optical group holding frame.

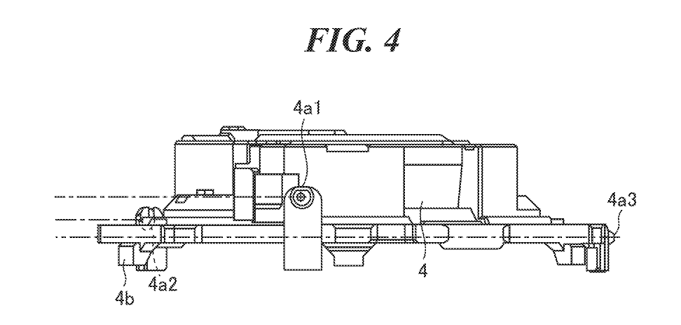

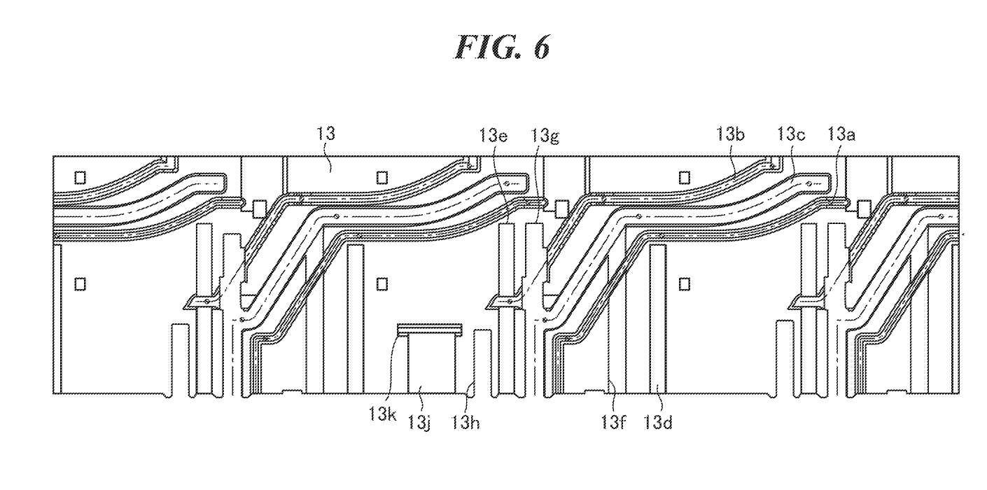

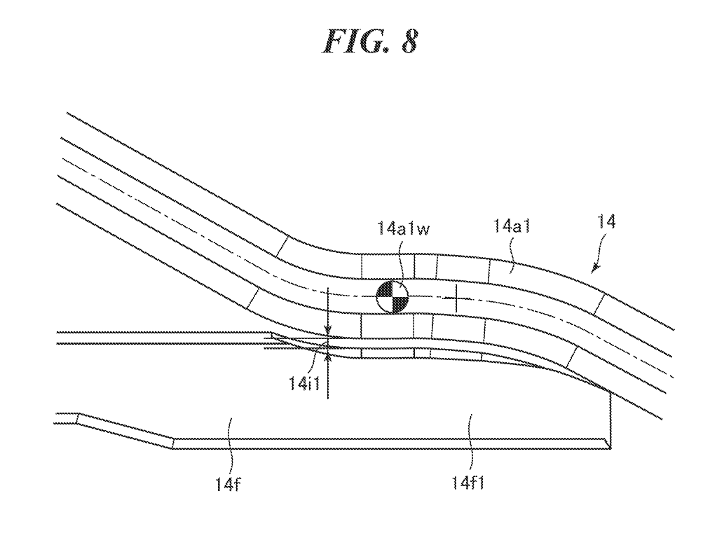

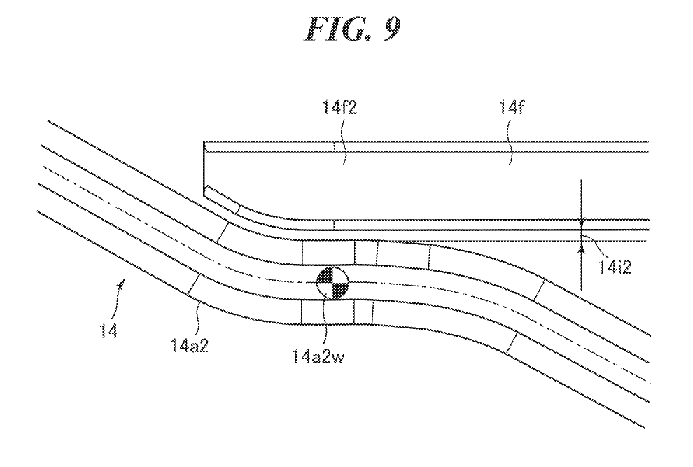

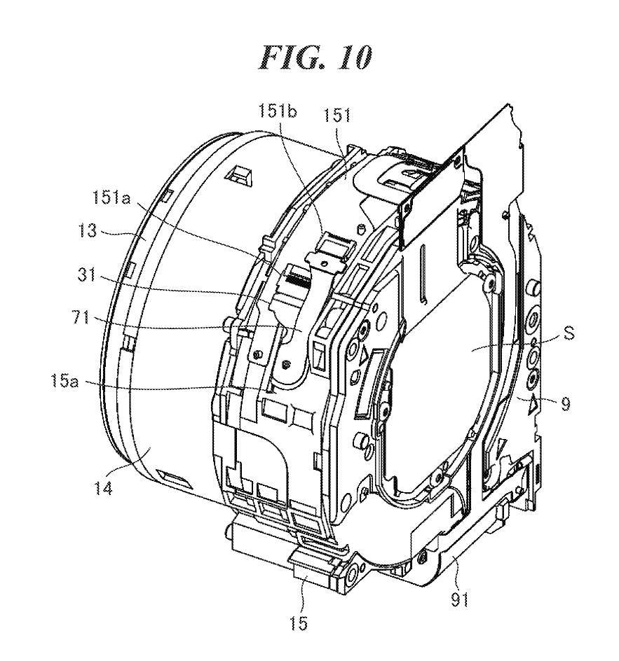

Next, referring to FIGS. 4 to 9, a description will be given of the placement of the cam grooves 14a1 to 14a3 and the cam grooves 14b1 to 14b3 on the driving cylinder 14. FIG. 4 is a side view of the group-4 holding frame 4. FIG. 5 is a side view of the group-6 holding frame 6. FIG. 6 is a developed view of an inner periphery of the fixed cylinder 13. FIG. 7 is a developed view of an inner periphery of the driving cylinder 14. FIG. 8 is a partially enlarged view of FIG. 7 and shows a collapsed region of a discharge slit in a flexible printed circuit board. The flexible printed circuit board will hereafter be referred to as the FPC. FIG. 9 is a partially enlarged view of FIG. 7 and shows a telephoto end region of the discharge slit in the FPC. FIG. 10 is a perspective view of the lens barrel in a state where the FPCs 31 and 71 of the image blur correction device 3 and the diaphragm device 7 are let out from the lens barrel.

As shown in FIG. 6, the cam grooves 13a, the through grooves 13c which are slit-shaped and take the same tracks as the cam grooves 13a, the cam grooves 13b for relief of the movable cover cylinder 16, and the rectilinear grooves 13d, 13e, and 13f are formed on the inner periphery of the fixed cylinder 13. Through grooves 13g and 13h extending in the direction of the optical axis are formed on the inner periphery of the fixed cylinder 13. Further, an FPC guide groove 13j for housing the FPCs 31 and 71 without catch them and an FPC insertion hole 13k into which the FPCs 31 and 71 are to be inserted are formed in the fixed cylinder 13.

The cam pins 10e (see FIG. 3) formed on an outer periphery of the cam cylinder 10 slide in contact with the cam grooves 13a. The driving pins 10f formed on the outer periphery of the cam cylinder 10 are formed a predetermined distance away from the through grooves 13c in the direction of the optical axis. The rectilinear keys 12a of the rectilinear plate 12 are engaged with the rectilinear grooves 13f such that the rectilinear keys 12a are able to slide in contact with the rectilinear grooves 13f. Rotation of the group-4 holding frame 4 is restricted by slidably engaging with the rectilinear grooves 13d. Rotation of the group-6 holding frame 6 is restricted by slidably engaging with the rectilinear grooves 13e.

As shown in FIG. 7, the group-4 driving cam grooves 14a1 to 14a3, the group-6 driving cam grooves 14b1 to 14b3, the FPC discharge slit 14f, the cam grooves 14c for driving the driving cylinder 14, and the rectilinear grooves 14d are formed on an inner periphery of the driving cylinder 14. The driving pins 10f of the cam cylinder 10 slide in contact with the rectilinear grooves 14d. Namely, movement of the cam cylinder 10 in the direction of the optical axis is restricted by the rectilinear grooves 14d.

As shown in FIG. 7, the rectilinear grooves 14d are formed a predetermined distance away from an end of the driving cylinder 14 on the subject side. If the rectilinear grooves 14d extend up to the end of the driving cylinder 14 on the subject side, this would cause entry of harmful light from outside through part where the rectilinear grooves 14d are formed and affect image quality.

According to the arrangement described above, an increased number of lens groups can be driven by additionally forming cam grooves, which are for moving the lens groups in the direction of the optical axis, in the driving cylinder 14 which rotates so as to move the cam cylinder 10 in the direction of the optical axis while rotating it. Moreover, the group-6 holding frame 6 which drives the group-5 holding frame 5 can be moved in a longer stroke in the direction of the optical axis.

As shown in FIG. 10, the FPCs 31 and 71 are let out from the interior of the lens barrel and routed around an outer periphery of the lens barrel. The FPCs 31 and 71 are connected to connectors 151a and 151b, respectively, provided on a lens barrel main FPC 151 connected to a main body power supply terminal (not shown). Electrically connecting the FPCs 31 and 71 to electronic components provided on the barrel main FPC 151 makes it possible to drive the image blur correction device 3, the diaphragm device 7, and a shutter inside the lens barrel.

A description will now be given of how the FPCs 31 and 71 are connected to the barrel main FPC 151 routed around the outer periphery of the lens barrel.

As described earlier, the FPC insertion hole 13k is formed in the fixed cylinder 13, and the FPC discharge slit 14f is formed in the driving cylinder 14. When the driving cylinder 14 is rotating, the image blur correction device 3 and the diaphragm device 7 linearly moves without rotating. Accordingly, the FPC discharge slit 14f is shaped like an elongate hole extending in the circumferential direction so as to prevent the image blur correction device 3 and the diaphragm device 7 from interfering with the driving cylinder 14.

The group-4 driving cam grooves 14a1 to 14a3 of the driving cylinder 14, which the FPC discharge slit 14f crosses in the direction of the optical axis, are formed predetermined distances (14i1, 14i2 (see FIGS. 8 and 9)) away from the cam grooves 14a. An FPC discharge hole 15a is formed in the fixed cover cylinder 15 in such a manner as to overlay the FPC insertion hole 13k. Thus, the FPC insertion hole 13k, the FPC discharge slit 14f, and the FPC discharge hole 15a overlay one another. As a result, the FPCs 31 and 71 pass through the FPC insertion hole 13k, the FPC discharge slit 14f, and the FPC discharge hole 15a in this order from the inside of the lens barrel and is guided to outside the lens barrel.

As shown in FIG. 7, a collapsed region 14f1 (a beginning) through which each FPC passes at the time of collapsing and a telephoto end region 14f2 (an end) through which each FPC passes at the time of photo shooting on the telephoto end are formed in the FPC discharge slit 14f in the circumferential direction. A circumference length of the FPC discharge slit 14f is determined by a width through which the FPC 31 is inserted and a rotational angle through which the driving cylinder 14 rotates.

A collapsed region from a wide-angle end region 14a1w of one group-4 driving cam groove 14a1 is formed on the image pickup element S side as viewed in the direction of the optical axis with respect to the collapsed region 14f1 of the FPC discharge slit 14f. A photographing region from a wide-angle end region 14a2w of another group-4 driving cam groove 14a2 is formed on the subject side in the direction of the optical axis with respect to the telephoto end region 14f2 of the FPC discharge slit 14f. Namely, the group-4 driving cam grooves 14a1 to 14a3 are formed at different locations in the direction of the optical axis so as not to interfere with the FPC discharge slit 14f.

The arrangement described above can increase the circumference length of the FPC discharge slit 14f in the driving cylinder 14, that is, the rotational angle through which the driving cylinder 14 rotates. Therefore, the lift of driving cam grooves in each lens group can be gentle, and as a result, the sensitivity of the lens group in terms of position, inclination, and so forth to rattling in the cam grooves can be eased. As shown in FIG. 4, the cam pins 4a1 to 4a3 of the group-4 holding frame 4 are also formed at different locations as with the group-4 driving cam grooves 14a1 to 14a3 of the driving cylinder 14.

Moreover, the group-6 driving cam grooves 14b1 to 14b3 of the driving cylinder 14 are also formed at different locations so as not to interfere with the FPC discharge slit 14f and the group-4 driving cam grooves 14a1 to 14a3. For example, the group-6 driving cam groove 14b2 is displaced toward the image pickup element S side so as not to interfere with the group-4 driving cam grooves 14a2 formed on the image pickup element S side in the direction of the optical axis with respect to the FPC discharge slit 14f.

The group-6 driving cam groove 14b3 is displaced toward the subject side so as not to interfere with the group-4 driving cam grooves 14a1 formed on the subject side in the direction of the optical axis with respect to the FPC discharge slit 14f. The cam pins 6a1 to 6a3 of the group-6 holding frame 6 are also formed at different locations as with the group-6 driving cam grooves 14b1 to 14b3 of the driving cylinder 14.

The rotational angle through which the driving cylinder 14 rotates can thus be increased by forming the group-4 driving cam grooves 14a1 to 14a3 of the driving cylinder 14 at different locations in the direction of the optical axis with respect to the FPC discharge slit 14f.

Moreover, telephoto side end portions 14a1t, 14a2t, and 14a3t of the group-4 driving cam grooves 14a1 to 14a3 and the rectilinear grooves 14d are placed in proximity to each other in phases that are adjacent in the circumferential direction. To place them in the same phases, the rectilinear grooves 14d need to be deep enough in a radial direction with respect to the group-4 driving cam grooves 14a1 to 14a3, that is, an outer diameter of the driving cylinder 14 needs to be large. For this reason, they are formed a predetermined distance away from the group-4 driving cam grooves 14a1 to 14a3.

Furthermore, collapsing side introducing portions 14a1s, 14a2s, and 14a3s of the group-4 driving cam grooves 14a1 to 14a3 and the rectilinear grooves 14d are placed at substantially the same positions in the circumferential direction. Areas where the group-4 driving cam grooves 14a1 to 14a3 and the rectilinear grooves 14d overlap are areas which the driving pins 10f do not slide in contact with when the cam cylinder 10 moves in the direction of the optical axis.

Since the group-4 driving cam grooves 14a1 to 14a3 are placed with respect to the rectilinear grooves 14d as described above, the circumference length of the group-4 driving cam grooves 14a1 to 14a3, that is, the rotational angle through which the driving cylinder 14 rotates can be increased while the outer diameter of the driving cylinder 14 is kept to a minimum. Therefore, the lift of driving cam grooves in each lens group can be gentle, and as a result, the sensitivity of the lens group in terms of position, inclination, and so forth to rattling in the cam grooves can be eased.

As described above, according to the present embodiment, the lens barrel and the camera equipped the lens barrel increase the moving range of the driving cylinder 14 having the FPC discharge slit 14f through which wiring for members in the lens barrel is let out to from the lens barrel.

It should be noted that the present invention is not limited to the illustrative embodiment described above, and materials, shapes, dimensions, forms, numbers, locations for arrangement, and so on can be appropriately changed as long as the concept of the present invention is not deviated.

For example, although in the embodiment described above, the lens barrel is of a two stage extendable type in which the group-1 cylinder 1 and the cam cylinder 10 move forward and backward, the present invention may be applied to a three or more stage extendable type in which three or more movable cylinders move forward and backward relatively to one another and also move forward and backward with respect to a camera main body.

Moreover, although in the above description of the embodiment, the lens barrel used for a digital compact camera is illustrated, but the present invention may be applied to a lens barrel for use in other image pickup apparatuses such as a digital video camera and a film camera. Further, in the above description of the embodiment, the group-4 driving cam grooves 14a1 to 14a3 are formed. However, four or more the group-4 driving cam grooves may be formed.

### OTHER EMBODIMENTS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-046802, filed Mar. 14, 2018, which is hereby incorporated by reference herein in its entirety.

What is claimed is:

1. A lens barrel comprising:
a flexible printed circuit board;
a driving cylinder on which at least three first cam grooves are formed and a slit through which the flexible printed circuit board is inserted is formed in a circumferential direction; and
a first optical group holding frame configured to move in a direction of an optical axis by following the at least three first cam grooves,
wherein the slit crosses the at least three first cam grooves in the direction of the optical axis, and the at least three first cam grooves are formed at different locations in the direction of the optical axis with respect to a beginning and an end of the slit.

2. The lens barrel according to claim 1, wherein
as for two of the at least three first cam grooves, a wide angle-end region of one of the two first cam grooves is placed on a subject side in the direction of the optical axis with respect to the beginning of the slit, and a wide-angle end region of the other one of the two first cam grooves is placed on an image pickup element side in the direction of the optical axis with respect to the end of the slit.

3. The lens barrel according to claim 2, wherein
an area from the wide-angle end region to a photographing region in one of the two first cam grooves is placed on the subject side in the direction of the optical axis with respect to the beginning of the slit, and an area from the wide-angle end region to a collapsed region in the other one of the two first cam grooves is placed on the image pickup element side in the direction of the optical axis with respect to the end of the slit.

4. The lens barrel according to claim 2, wherein three second cam grooves for moving a second optical group holding frame in the direction of the optical axis are formed on the driving cylinder, and at least one of the three second cam grooves is displaced with respect to the other second cam grooves in the direction of the optical axis.

5. The lens barrel according to claim 1, wherein rectilinear grooves for rotating a cam cylinder that rotates a third optical group holding frame in the direction of the optical axis is formed on the driving cylinder, and one end of each of the at least three first cam grooves is formed at a location close to the rectilinear groove in a circumferential direction of the driving cylinder, and the other end is formed at substantially the same location as the rectilinear groove in the circumferential direction of the driving cylinder.

6. An image pickup apparatus comprising:
a lens barrel, wherein
the lens barrel includes:
a flexible printed circuit board;
a driving cylinder on which at least three first cam grooves are formed, and a slit through which the flexible printed circuit board is inserted is formed in a circumferential direction; and
a first optical group holding frame configured to move in a direction of an optical axis by following the at least three first cam grooves,
wherein the slit crosses the at least three first cam grooves in the direction of the optical axis, and the at least three first cam grooves are formed at different locations in the direction of the optical axis with respect to a beginning and an end of the slit.
